(19) United States
(12) Patent Application Publication
(10) Pub. No.: US 2015/0143899 A1
(43) Pub. Date: May 28, 2015

(54) RESIDUAL QUANTITY SENSOR

(71) Applicant: DENSO CORPORATION, Kariya-city (JP)

(72) Inventor: Kenji YAMAMOTO, Chita-gun (JP)

(21) Appl. No.: 14/546,543

(22) Filed: Nov. 18, 2014

(30) Foreign Application Priority Data
Nov. 22, 2013 (JP) 2013-241861

(51) Int. Cl. G01F 23/24

(52) U.S. Cl. CPC G01F 23/24
USPC 73/304 R

(57) ABSTRACT

A residual quantity sensor includes a conductive member having a first insulated wire and a second insulated wire. The first insulated wire and the second insulated wire have bared portions at an end thereof to provide a first electrode and a second electrode. The first electrode and the second electrode provide an electrode section of the conductive member. The first insulated wire and the second insulated wire are twisted to each other at a part thereof to provide a twisted section of the conductive member. The conductive member is to be installed to a tank such that the electrode section is disposed in a tank body, and the twisted section is extended to an outside of the tank through a vent hole of a tank cap attached to the tank body.

### CROSS REFERENCE TO RELATED APPLICATION

This application is based on Japanese Patent Application No. 2013-241861 filed on Nov. 22, 2013, the disclosure of which is incorporated herein by reference.

### TECHNICAL FIELD

The present disclosure relates to a residual quantity sensor that detects a residual quantity of liquid stored in a tank.

### BACKGROUND

For example, JP 2000-074724 A discloses a device for detecting a groundwater level. In the device, a conical drill is fixed to an end of a hollow pipe, and a water level sensor, which is provided with two lead wires and electrodes fixed at the ends of the lead wires, is disposed in the hollow pipe. The hollow pipe is penetrated into the ground, and an electric resistance value between the electrodes is measured. The groundwater level is detected based on a change of the electric resistance value.

JP 09-026350 A discloses a structure of electrodes having different length for detecting a change of a liquid level. An alert signal indicating the change of the liquid level is outputted based on a conduction state between the electrodes.

In vehicles, a washer liquid residual quantity detector may be mounted in a washer liquid tank to detect a residual quantity of a washer liquid for washing a windshield or a rear glass.

### SUMMARY

In a case where a residual quantity sensor is installed in a washer liquid tank of a vehicle after production or sale of the vehicle, it is necessary to insert a residual quantity sensor in a tank body of the washer liquid tank mounted in the vehicle, and to fix a connector or a metal fitting to the tank body or a tank cap so as to draw a signal wire from the residual quantity sensor to the outside of the washer liquid tank. Further, it is necessary to form a hole in the tank body or the tank cap in order to fix the connector or the fitting metal to the tank body or the tank cap.

Namely, in the case where the residual quantity sensor is attached to the tank by post-installation, it is necessary to add the change of structure to the tank.

The present disclosure is made in view of the foregoing issues, and it is an object of the present disclosure to provide a residual quantity sensor that is capable of being installed to a tank without requiring a change of structure to a tank.

According to an aspect of the present disclosure, a residual quantity sensor is for detecting a residual quantity of a liquid stored in a tank, which has a tank body and a tank cap formed with a vent hole. The residual quantity sensor includes a conductive member having a first insulated wire and a second insulated wire. The conductive member has an electrode section and a twisted section. The electrode section includes a first electrode and a second electrode provided by bared portions of the first insulated wire and the second insulated wire. The twisted section is provided by portions of the first and second insulated wires twisted to each other. The conductive member is to be installed to the tank such that the electrode section is disposed in the tank body, and the twisted section is extended to an outside of the tank through the vent hole of the tank cap attached to the tank body.

In the structure described above, the residual quantity sensor can be installed to the tank without requiring the change of the structure of the tank.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1A is a plan view of a residual quantity sensor according to an embodiment of the present disclosure;

FIG. 1B is a side view of the residual quantity sensor according to the embodiment;

FIG. 2 is a schematic view of a conductive member of the residual quantity sensor according to the embodiment;

FIG. 3 is a schematic view of a holding member of the residual quantity sensor according to the embodiment;

FIGS. 4A to 4C are schematic views for explaining installation of the residual quantity sensor to a tank according to the embodiment;

FIG. 5 is a schematic view for explaining the installation of the residual quantity sensor to the tank according to the embodiment;

FIG. 6A is a schematic view of a holding member of a residual quantity sensor as a modification to the embodiment; and

FIG. 6B is a schematic view of a holding member of a residual quantity sensor as another modification to the embodiment.

### DETAILED DESCRIPTION

Embodiments of the present disclosure will be hereinafter described with reference to the drawings.

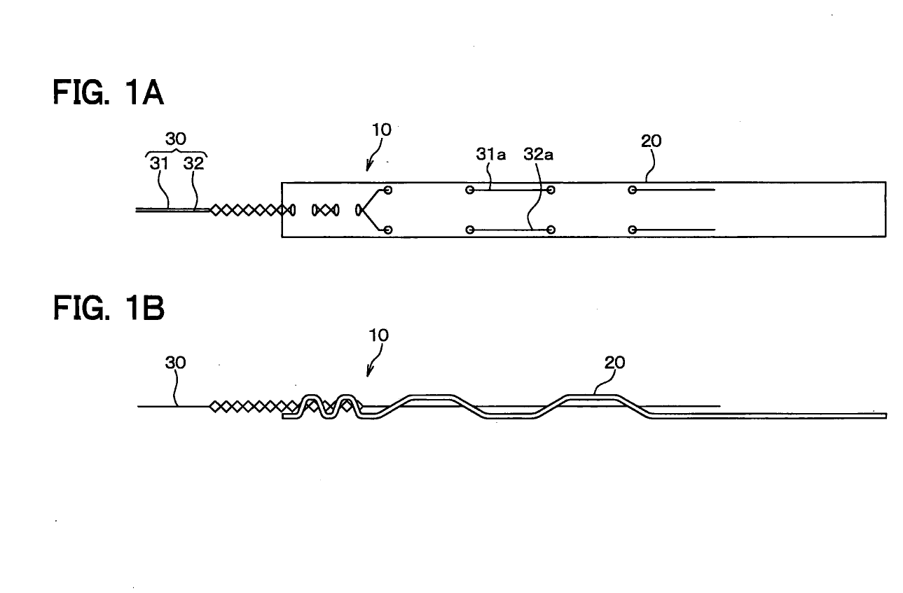

Referring to FIGS. 1A and 1B, a residual quantity sensor 10 of an embodiment is configured to detect a residual quantity of a liquid in a tank, such as a washer liquid for washing a front windshield or a rear window of a vehicle.

The residual quantity sensor 10 generally includes a conductive member 30 and a holding member 20 that holds the conductive member 30. The conductive member 30 includes a pair of insulated wires 31, 32, such as a first insulated wire 31 and a second insulated wire 32.

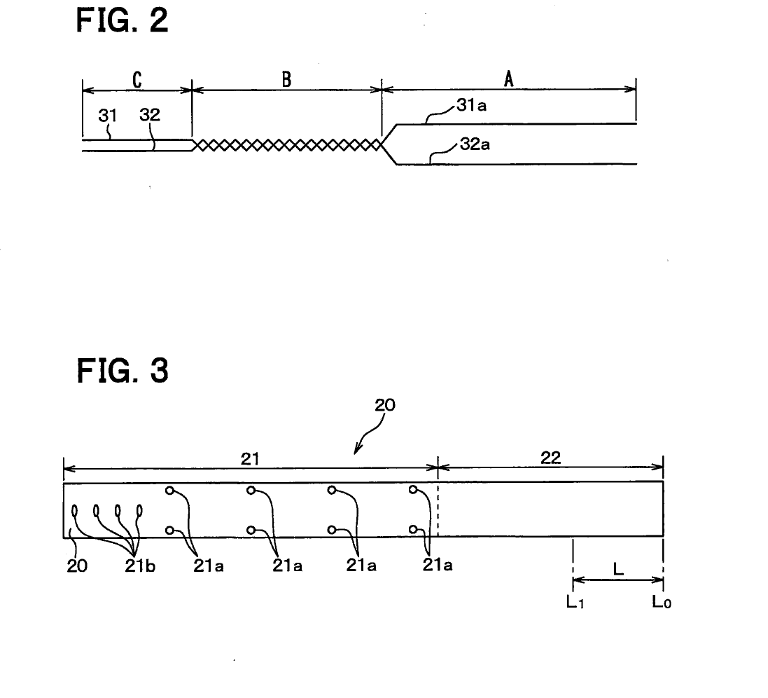

Referring to FIG. 2, the conductive member 30 has an electrode section A, a signal transmitting section B and a terminal section C. The electrode section A is provided at a first end of the first and second insulated wires 31, 32. The terminal section C is provided at a second end of the first and second insulated wires 31, 32 opposite to the first end. The signal transmitting section B is provided at an intermediate portion between the first end and the second end of the first and second insulated wires 31, 32. The signal transmitting section B corresponds to a twisted section at which the first and second insulated wires 31, 32 are twisted to each other.

In the electrode section A, the first and second insulated wires 31, 32 are bared, and provide two electrodes 31a, 32a, such as a first electrode 31a and a second electrode 32a. In other words, the electrode section A includes the first electrode 31a and the second electrode 32a provided by bared portions of the first and second insulated wires 31, 32.

In the signal transmitting section B, the first and second insulated wires 31, 32 are twisted with each other to form a paired-twisted structure. In the terminal section C, the first and second insulated wires 31, 32 are bared, and provide two terminals. In other words, the terminal section C includes two terminals, such as a first terminal and a second terminal, provided by bared portions of the first and second insulated wires 31, 32.

Each of the first and second insulated wires 31, 32 has a core wire made of stainless steel and having a diameter of 0.6 millimeters (mm). Thus, the first and second insulated wires 31, 32 are easily deformable.

Referring to FIG. 3, the holding member 20 is used to hold the conductive member 30. The holding member 20 holds the conductive member 30 in such a manner that a distance between the first electrode 31a and the second electrode 32a is kept constant.

The holding member 20 is provided by a long sheet member made of resin, such as polypropylene. For example, the holding member 20 has a thickness of 0.8 mm.

The holding member 20 holds the first and second electrodes 31a, 32a such that the distance between the first electrode 31a and the second electrode 32a is kept constant. Therefore, it is less likely that the first and second electrodes 31a, 32a will contact with each other, and will cause short-circuit therebetween. Also, the holding member 20 reinforces the conductive member 30.

The holding member 20 has an electrode-holding portion 21 and a length adjustment portion 22 extending from the electrode-holding portion 21. The electrode-holding portion 21 is formed with first holes 21a for holding each of the first and second electrodes 31a, 32a of the electrode section A, and second holes 21b for holding the signal transmitting section B.

As shown in FIGS. 1A and 1B, the first and second electrodes 31a, 32a are inserted into the first holes 21a so that the first and second electrodes 31a, 32a extend alternately along a front surface and a rear surface of the holding member 20. The signal transmitting portion B is inserted into the second holes 21b so that the signal transmitting portion B extend alternately along the front surface and the rear surface of the holding member 20.

The first and second electrodes 31a, 32a of the electrode section A are held in parallel to each other by the holding member 20. For example, the first holes 21a are arranged in two lines along a longitudinal direction of the holding member 20, one extending along a first side of the holding member 20, and the other extending along a second side of the holding member 20.

The length adjustment portion 22 is provided to adjust the length of the holding member 20. The length adjustment portion 22 is cut into a suitable length according to the size, structure, and shape of a tank 40 to which the residual quantity sensor 10 is installed.

For example, the length adjustment portion 22 is made to have a sufficient length so that the residual quantity sensor 10 can be installed to a relatively large tank. The cutting of the length adjustment potion 22 will be described later in detail.

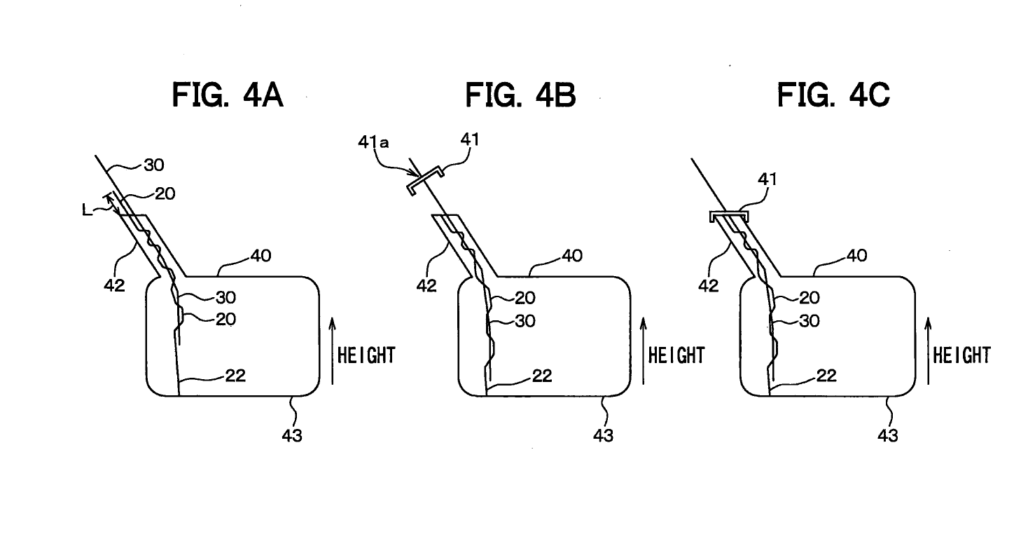

Referring to FIGS. 4A to 4C, installation of the residual quantity sensor 10 to the tank 40 will be described.

The tank 40 has a tank body 43 and a tank cap 41. The tank body 43 has an inlet portion 42. The tank cap 41 is attached to an upper end of the inlet portion 42.

As shown in FIG. 4A, the residual quantity sensor 10 in which the electrode member 30 has been held by the holding member 20 as shown in FIGS. 1A and 1B is inserted to the tank body 43. Specifically, the length adjustment portion 22 of the holding member 20 is inserted into the tank body 43 from the inlet portion 42.

When the residual quantity sensor 10 is inserted into the tank body 43, the end of the length adjustment portion 22 is brought into contact with the bottom of the tank body 43. In this case, since the length adjustment portion 22 is sufficiently long, the holding member 20 projects out from the upper end of the inlet portion 42. For example, the holding member 20 projects out from the upper end of the inlet portion 42 by the length of L mm.

In the case where the holding member 20 projects out from the upper end of the inlet portion 42 by the length of L mm, the residual quantity sensor 10 is removed once from the tank body 43 and then the length adjustment portion 22 is cut by the length of L mm. Specifically, as shown in FIG. 3, the length adjustment portion 22 is cut at a position L₁ from an end L₀ by the length of L mm by a cutting tool or the like.

As described above, the length adjustment portion 22 is cut into a suitable length so that the holding member 20 is received in a space between the upper end of the inlet portion 42 and the bottom of the tank body 43. The upper end of the inlet portion 42 corresponds to a position where the tank cap 41 is attached.

When the residual quantity sensor 10 is inserted into the tank body 43 again from the length adjustment portion 22 through the inlet portion 42, the end of the length adjustment portion 22 is brought into contact with the bottom of the tank body 43, as shown in FIG. 4B. In this case, the holding member 20 is received within the space between the upper end of the inlet portion 42 and the bottom of the tank body 43 without projecting out from the upper end of the inlet portion 42.

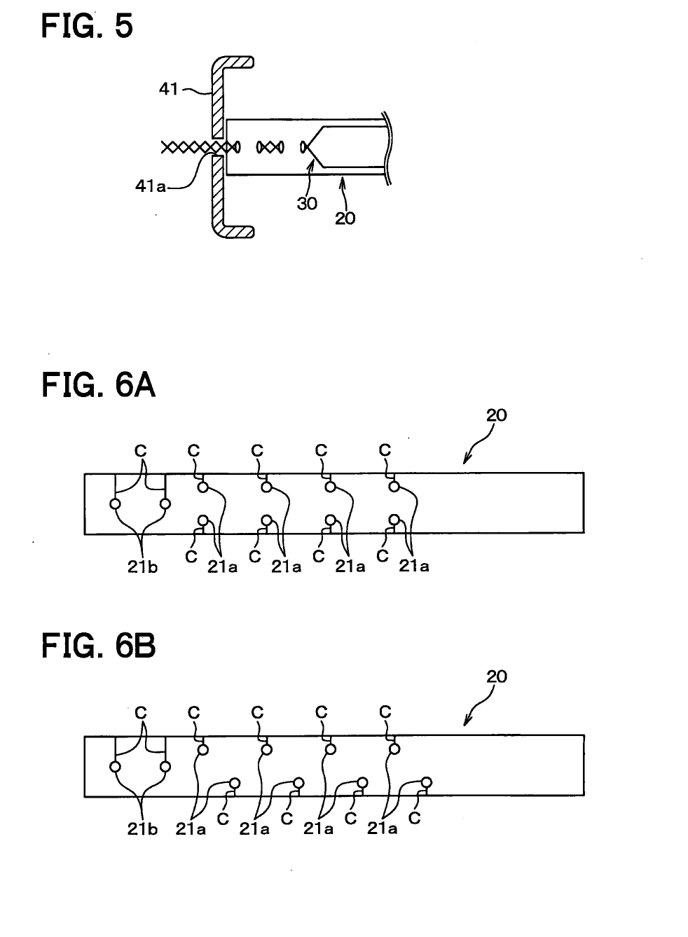

In the state where the holding member 20 holding the electrode section A of the conductive member 30 thereon is received in the tank body 43, as shown in FIGS. 4B and 5, the terminal section C and the signal transmitting section B of the conductive member 30 are inserted into a vent hole 41a of the tank cap 41 such that the signal transmitting section B is drawn out of the tank 40 through the vent hole 41a.

Lastly, as shown in FIG. 4C, the tank cap 41 is fixed to the upper end of the inlet portion 42. In this way, the installation of the residual quantity sensor 10 to the tank 40 finishes.

It is to be noted that the terminal section C of the conductive member 30 is extended out of the tank 40 through the vent hole 41a of the tank cap 41, and a detection circuit or the like (not shown) is connected between the first and second terminals of the terminal section C.

In the structure described above, the residual quantity sensor 10 includes the conductive member 30. The conductive member 30 includes the first and second insulated wires 31, 32. The conductive member 30 has the electrode section A at which the insulated wires 31, 32 include bared portions and provide the first and second electrodes 31a, 32a, and the twisted section B at which the first and second insulated wires 31, 32 are partly twisted to each other.

The tank 40 has the tank cap 41 formed with the vent hole 41a. The residual quantity sensor 10 is installed to the tank 40 such that the electrode section A is arranged inside of the tank body 43 and the twisted section B is inserted in the vent hole 41 a of the tank cap 41 to be extended to the outside of the tank 40 through the vent hole 41a.

In this case, the residual quantity sensor 10 can be installed to the tank 40 without requiring forming a hole in the tank body 43 or the tank cap 41, fixing a connector, a fitting metal or the like to the tank 40, or changing the structure of the tank 40. The residual quantity sensor 10 can be easily installed to the tank 40.

The residual quantity sensor 10 has the holding member 20. The holding member 20 holds the conductive member 30 such that the first and second electrodes 31a, 32a are spaced apart from each other by a predetermined distance at least. Therefore, it is less likely that the first and second electrodes 31a, 32a will contact each other, and will cause sort-circuit. Further, the conductive member 30 can be reinforced by the holding member 20.

In vehicles, the size, shape and structure of a washer liquid tank are different depending on types and the like. In the present embodiment, the holding member 20 has the length adjustment portion 22. The length adjustment portion 22 can be cut into a desired length so that the holding member 20 is received within the tank 40 between the bottom of the tank body 43 and the tank cap 41. Therefore, the holding member 20 can be properly received in the tank 40 between the bottom of the tank body 43 and the tank cap 41, irrespective of the types of the tank 40 to which the residual quantity sensor 10 is installed.

The holding member 20 is made of a resin sheet member having a thickness equal to or less than a predetermined thickness. Therefore, the holding member 20 is deformable according to the shape of the tank 40. As such, even if the inlet portion 42 of the tank body 43 has a complicated shape, such as bellows shape or bent shape, the holding member 20 can be inserted in the tank 40.

The present disclosure is not limited to the embodiment described hereinabove, but may be modified in various other ways without departing from the gist of the present disclosure.

In the embodiment described above, the residual quantity sensor 10 has the holding member 20. However, it is not always necessary to have the holding member 20.

In the embodiment, the residual quantity sensor 10 is employed to detect the residual quantity of the washer liquid for washing the front windshield or the rear window of the vehicle. However, the use of the residual quantity sensor 10 may not be limited to the detection of the residual quantity of the washer liquid. The residual quantity sensor 10 may be employed to detect a liquid level of any other liquid.

In the embodiment described above, the holding member 20 is the resin sheet member having the thickness of 0.8 mm. Considering the ease of the cutting, the deformation, the strength and the like, the thickness of the holding member 20 is preferably equal to or less than 1 mm, though it may depend on the material of the holding member 20. The thickness of the holding member 20 may be determined depending on the material. The holding member 20 may be made of any material, other than the resin. The holding member 20 may have any shape, other than the sheet shape.

In the embodiment described above, the core wire of the first and second insulated wires 31, 32 is made of stainless steel and has the diameter of 0.6 mm. However, the diameter and the material of the core wire may not be limited to the example described above, but may be suitably determined.

In the embodiment described above, the conductive member 30 is held by the holding member 20 such that the first and second electrodes 31a, 32a are parallel to each other. However, it is not always necessary to hold the conductive member 30 on the holding member 20 such that the first and second electrodes 31a, 32a are parallel to each other. For example, the conductive member 30 is held on the holding member 20 such that the first and second electrodes 31a, 32a are spaced from each other at least by a predetermined distance.

In the embodiment described above, as shown in FIG. 3, the electrode-holding portion 21 is formed with the first holes 21a and the second holes 21b. As another example, the electrode-holding portion 21 is further formed with slits C each of which extends from the side of the electrode-holding portion 21 to the first or second hole 21a, 21b, as shown in FIG. 6A.

As further another example, the first holes 21a on the first side of the electrode-holding portion 21 and the first holes 21a on the second side of the electrode-holding portion 21 may be alternately arranged, that is, staggered in the longitudinal direction of the holding member 20. Also in this case, the slits C may be formed to extend from one of the first side and the second side to the first and second holes 21a, 21b.

In the case where the holding member 20 has the slits C, the conductive member 30 can be easily inserted to the first and second holes 21a, 21b. Therefore, fabrication of the conductive member 30 to the holding member 20 enhances.

While only the selected exemplary embodiment and examples have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiment and examples according to the present disclosure is provided for illustration only, and not for the purpose of limiting the disclosure as defined by the appended claims and their equivalents.

What is claimed is:

1. A residual quantity sensor for detecting a residual quantity of a liquid stored in a tank, the tank having a tank body and a tank cap that is attached to the tank body and formed with a vent hole, the residual quantity sensor comprising
a conductive member including a first insulated wire and a second insulated wire, the first insulated wire and the second insulated wire having bared portions at an end thereof to provide a first electrode and a second electrode, the first electrode and the second electrode providing an electrode section of the conductive member, the first insulated wire and the second insulated wire partly having twisted portions at which the first insulated wire and the second insulated wire are twisted to each other to provide a twisted section of the conductive member, wherein
the conductive member is to be installed to the tank such that the electrode section is disposed in the tank body, and the twisted section is extended to an outside of the tank through the vent hole of the tank cap attached to the tank body.

2. The residual quantity sensor according to claim 1, further comprising
a holding member having an elongated shape, wherein
the holding member holds the conductive member such that the first electrode and the second electrode are spaced from each other at least by a predetermined distance.

3. The residual quantity sensor according to claim 2, wherein
the holding member has an electrode-holding portion on which the first electrode and the second electrode are held, and a length adjustment portion extending from the electrode-holding portion to adjust a length of the holding member such that the holding member is received in a space between the tank cap and a bottom of the tank body within the tank.

4. The residual quantity sensor according to claim 2, wherein
the holding member is made of a resin sheet member having a thickness of 1 mm or less.
